(19) United States
(12) Patent Application Publication
(10) Pub. No.: US 2009/0138849 A1
(43) Pub. Date: May 28, 2009

(54) Enhanced Prompting in a Visual Editor

(75) Inventor: Don Syme, Grantchester (GB)

Correspondence Address: LEE & HAYES, PLLC, 601 W. RIVERSIDE AVENUE, SUITE 1400, SPOKANE, WA, 99201, US

(73) Assignee: Microsoft Corporation, Redmond, WA (US)

(21) Appl. No.: 11/929,131

(22) Filed: Oct. 30, 2007

(51) Int. Cl. G06F 9/44

(52) U.S. Cl. 717/113

(57) ABSTRACT

A method of providing enhanced prompts in a visual editing environment is described. In an embodiment, these prompts may assist a programmer by identifying a set of possible decomposition cases following a decomposition statement relating to a variable. These possible decomposition cases are determined based on the variable's type. These possible cases are then refined based on existing decomposition constructs within the code to provide the user with a visual prompt of only those possible cases which have not already been considered. The process may be repeated as the programmer continues to write code such that the list of possible decomposition cases is iteratively refined.

### BACKGROUND

Visual editors, such as Visual Studio 2005™ are commonly used by programmers when writing code. These editors provide the programmers with prompts, on request, which offer menus of choices of possible routes to completion based on context dependent information, e.g. all possible values that read from a particular point in the code based on inferred type. Prompts may also be used to provide other information to programmers, such as details of errors which have been detected (e.g. a type error) and inferred types for identifiers.

### SUMMARY

The following presents a simplified summary of the disclosure in order to provide a basic understanding to the reader. This summary is not an extensive overview of the disclosure and it does not identify key/critical elements of the invention or delineate the scope of the invention. Its sole purpose is to present some concepts disclosed herein in a simplified form as a prelude to the more detailed description that is presented later.

A method of providing enhanced prompts in a visual editing environment is described. In an embodiment, these prompts may assist a programmer by identifying a set of possible decomposition cases following a decomposition statement relating to a variable. These possible decomposition cases are determined based on the variable's type. These possible cases are then refined based on existing decomposition constructs within the code to provide the user with a visual prompt of only those possible cases which have not already been considered. The process may be repeated as the programmer continues to write code such that the list of possible decomposition cases is iteratively refined.

Many of the attendant features will be more readily appreciated as the same becomes better understood by reference to the following detailed description considered in connection with the accompanying drawings.

### DESCRIPTION OF THE DRAWINGS

The present description will be better understood from the following detailed description read in light of the accompanying drawings, wherein:

FIG. 1 shows an example flow diagram of a method of providing enhanced prompts in a visual editing environment;

FIG. 2 shows an example flow diagram of a second method of providing enhanced prompts in a visual editing environment;

FIG. 3 shows an example flow diagram of a third method of providing enhanced prompts in a visual editing environment;

FIG. 4 shows an example flow diagram of a method of determining the type of input being examined; and

FIG. 5 illustrates an exemplary computing-based device in which embodiments of the methods described herein may be implemented.

Like reference numerals are used to designate like parts in the accompanying drawings.

### DETAILED DESCRIPTION

The detailed description provided below in connection with the appended drawings is intended as a description of the present examples and is not intended to represent the only forms in which the present example may be constructed or utilized. The description sets forth the functions of the example and the sequence of steps for constructing and operating the example. However, the same or equivalent functions and sequences may be accomplished by different examples.

Whilst existing visual editors, such as Visual Studio 2005 (trade mark) provide a number of different prompts to a programmer, if prompts are provided in relation to decomposition statements (or expressions), these are limited to providing a list of all possible cases and/or to identifying replication. Examples of such decomposition statements include switch statements in C# and C++, match . . . with statements in F# and OCaml and case statements in Haskell. All these languages involve expressions and types.

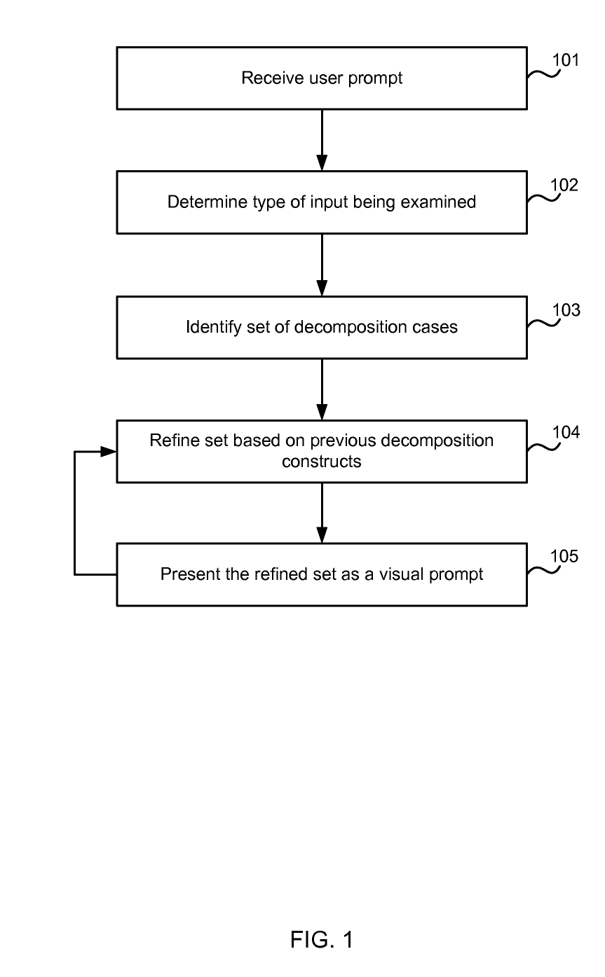

FIG. 1 shows an example flow diagram of a method of providing enhanced prompts in a visual editing environment. The method may be initiated on receipt of a user prompt (block 101) or alternatively the method may run automatically (e.g. initiated by detection of a decomposition statement). The type of the input being examined is determined (block 102) and from this type information, a set of possible decomposition cases is identified (block 103). This set of possible decomposition cases is refined (in block 104) based on the previous decomposition constructs in the code being edited/written and this refined set is presented to the user as a visual prompt (block 105). The set may be repeatedly refined (by repeating blocks 104 and 105 as indicated by the arrow in FIG. 1) as the user continues to enter characters and decomposition constructs. Alternatively the set may only be further refined on receipt of a user prompt.

In an example, the user may have written the following decomposition statement and requested a prompt at the position shown:

match xs with
   |A->
   |<prompt>
   The type of the variable xs is determined (block 102) and the set of decomposition cases for this type is identified (block 103), which may for example be (A|B|C|D). The set is refined to remove the case which has already been covered, i.e. A, and the refined set of B, C, D is presented to the user as a visual prompt.

Functional programming languages may be extended through the use of active patterns, as described in the paper by D. Syme, G. Neverov and J. Margetson entitled ‘Extensible Pattern Matching via a Lightweight Language Extension’ and published on http://blogs.msdn.com/dsyme/ on 7 Apr. 2007. Active patterns supports pattern matching over abstract representations of generic heterogeneous data such as XML and term structures. They enable multiple ways of decomposing for a particular type and enable a programmer to define their own patterns. This paper describes the use of active patterns in F#, however the concept of active patterns may also be introduced into other functional programming languages and other languages involving decomposition constructs. A definition of active patterns is provided below.

An active recognizer, which may also be referred to as an active pattern, is a regular function, but it is defined using a new syntactic element called a structured name which gives it special significance in the particular programming language. The names of active recognizers take the form (|id| . . . |id|{|}?), as shown in the table below. When an active recognizer is in scope the individual identifiers in the name of the active recognizer are in scope as pattern tags (i.e. pattern constructors), and the patterns formed using these tags are called active patterns. A well-formed active recognizer has type:

τ₁→ . . . →τ_{N}→τᵢₙₚ→τ

for some N≧0, where the N initial arguments are the parameters to the recognizer and the last argument is the input that is matched on. The return type must conform to the shape indicated in the able below based on the form of the structured name, if not a type error will result on use. The input argument of type τᵢₙₚ can be any type including abstract types, primitive types, union types and object types. Moreover a type can have any number of active recognizers that match it. Both recognizers and their patterns may be referred to as ‘active patterns’.

The following table shows the kinds of active recognizers and their structured names:

| Structured Name | Kind | Expected Return Type |
|---|---|---|
| (\|A\|) | Single-case total | a |
| (\|A1\| . . . \|An\|) | Multi-case total | (a1, . . . , an) choice |
| (\|A\| \|) | Single-case partial | a option |
| (\|A1\| . . . \|An\| \|) | Multi-case partial | (a1, . . . , an) choice option |

The table shows that active patterns may decompose types into a complete set of sub-cases (‘total patterns’) or into an incomplete (and possibly overlapping) set of sub-cases (‘partial patterns’) where new parse patterns may be subsequently added. A partial active pattern is defined using a structured name with a trailing underscore to indicate the incompleteness of a match. A partial pattern either succeeds and yields residual data or it fails. A failure indicates that other patterns in the match block should be tried.

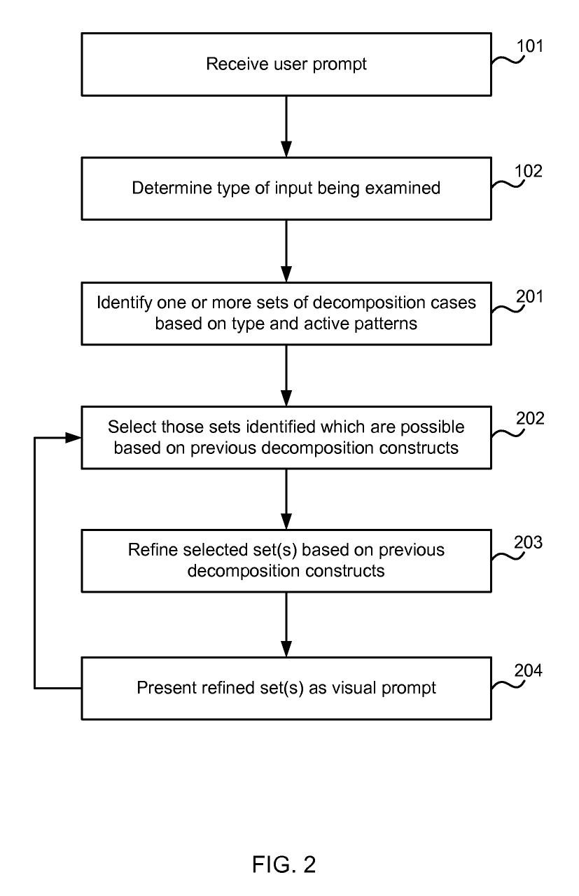

As a result of using active patterns, there may be multiple ways to decompose a particular type and therefore it is more complicated for a programmer to ensure that any decomposition is complete and correct. In this situation, visual prompting is very useful. FIG. 2 shows an example flow diagram of a second method of providing enhanced prompts in a visual editing environment. As described above, the method may be initiated on receipt of a user prompt (block 101) or alternatively the method may run automatically (e.g. initiated by detection of a decomposition statement). The type of the input being examined is determined (block 102) and this type may vary dependent upon the location of the prompt. The type information and active patterns are used to identify one or more sets of possible decomposition cases (block 201). This identification may be achieved through analysis of the earlier code where the active patterns are defined, as demonstrated in the examples provided below. One or more sets are then selected (block 202) from those one or more sets identified (in block 201) based on previous decomposition constructs, and the selected set(s) are then refined (block 203), also based on the previous decomposition constructs in the code being edited/written and the refined set(s) are presented to the user as a visual prompt (block 204). The sets may be repeatedly selected from those identified and the refined set(s) may be repeatedly refined (by repeating blocks 202-204 as indicated by the arrow in FIG. 2) as the user continues to enter characters and decomposition constructs. Alternatively the set may only be further refined on receipt of a user prompt.

In an example, the user may have written the following decomposition statement and requested a prompt at the position shown:

match xs with
   |<prompt>
   The type of the variable xs is determined (block 102) and the sets of decomposition cases for this type are identified (block 201). For example, two active patterns may have been defined for this particular type: (A|B|C|D) and (E|F). As there are no previous decomposition constructs, both sets of decomposition cases are selected (in block 202) and these are not refined further (in block 203). All six decomposition options, A, B, C, D, E, F, are then presented to the user in a visual prompt (in block 204). If the user then continues to enter a decomposition construct and request a further prompt at the position shown:

match xs with
   |A->
   |<prompt>
   when the possible sets are selected (in block 202) only the first set, (A|B|C|D), is selected and this is refined (in block 203) to remove case A which has already been covered, such that the refined set of B, C, D is presented to the user in a visual prompt (block 204). The second set, (E|F), is not selected (in block 202) because based on the previous decomposition constructs (i.e. |A-> in this example) this active pattern cannot be used (as A is not a member of the second set).

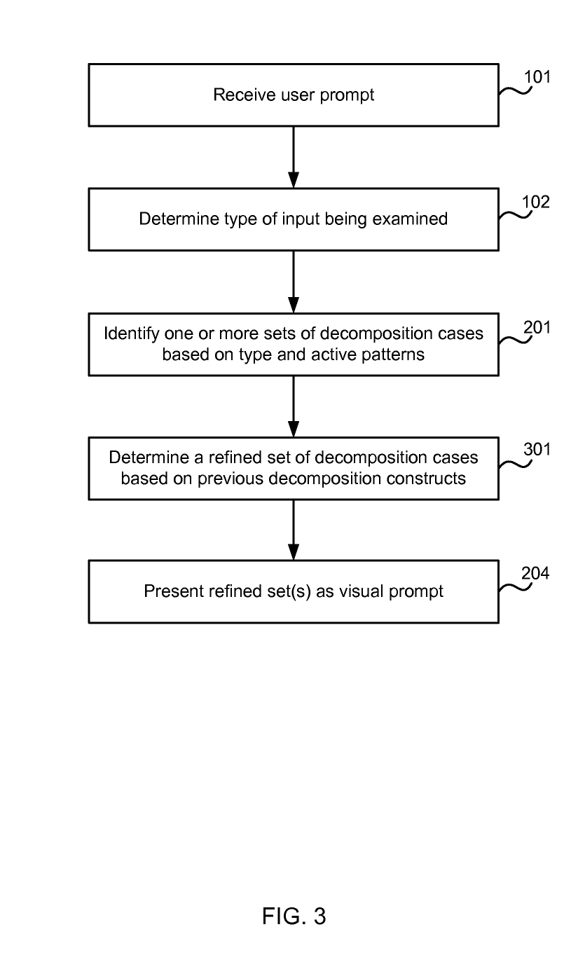

Although in FIG. 2 the selection of sets from those identified (block 202) and the refinement of the selected set(s) (block 203) are shown separately, these method steps may be combined into a single step (block 301) as shown in FIG. 3.

The type of input being examined may be determined (block 102) using a pattern match compilation algorithm, such as that described in section 3.1 (and shown in FIG. 8) of the paper by K. Scott and N. Ramsey entitled ‘When Do Match-Compilation Heuristics Matter?’ which was published as Technical Report CS-2000-13 from the University of Virginia in 2000 (available at citeseer.ist.psu.edu/scott00when.html). This algorithm is also discussed in section 5 of the paper by Syme, Neverov and Margetson (full reference given above) and is described below.

In the generalized pattern compilation algorithm with a left-to-right heuristic, which is described in the paper referenced above, the heuristic chooses a point of investigation from a collection of frontiers. A point of investigation roughly corresponds to a single switch on an integer or tag and is represented by a path, which is a sequence of integers roughly indicating a subterm of the input term. From this, the frontiers are divided into those edges that are relevant, i.e. where information from the investigation may result in the failure of the rule, and those that are tips. A decision tree is then constructed that incorporates the test and has subtrees corresponding to projecting the success/failure of the investigation through the relevant edge. A default case is added for the tips. The process may then be repeated. Typically, the process may be repeated until all frontiers are exhausted, and match incompleteness warnings can be given if a final “dummy” rule is ever exercised. However, in determining the type of input being examined (block 102), the algorithm may be terminated when there is a frontier at the position of the prompt (i.e. at the point where the next input is expected).

Where active patterns are used, the algorithm may be modified and three modifications are described: choosing the edge set, pattern identity and path identifiers and rule chunking.

In pattern matching without active patterns all edges with any kind of concrete pattern are actually relevant to the investigation. However, with active patterns this assumption is no longer valid. For active patterns, the algorithm may be modified by, when partitioning edges, choosing a prefix of relevant edges based on the point of investigation, where all the edges are related to the same pattern. If the pattern has no identity, i.e. is a parameterized active pattern, then only the first relevant edge is chosen.

The second modification, relates to the fact that uses of active patterns without identity must be considered to have different ‘paths’. The notion of path is extended by this modification so that different instances of parameterized patterns encountered through pattern match compilation are allocated fresh, unique integers and these integers are used within paths.

The extensive use of active patterns (particularly partial patterns) can quickly lead to significant (even exponential) blow up in the size of generated decision trees. This is partly due to the fact that failing sub-patterns can lead to duplications of the large frontier sets that are used to investigate multiple rules simultaneously. The third modification to the algorithm involves abandoning the use of large frontier sets whenever partial patterns are used. When compiling N rules, the rules may be compiled simultaneously, one-by-one, or in chunks. According to this third modification, a prefix of rules up to the first that uses any kind of partial pattern is selected as a chunk to be compiled simultaneously. This may result in active patterns being called more times than may be expected, but reduces code size substantially on some real-world examples.

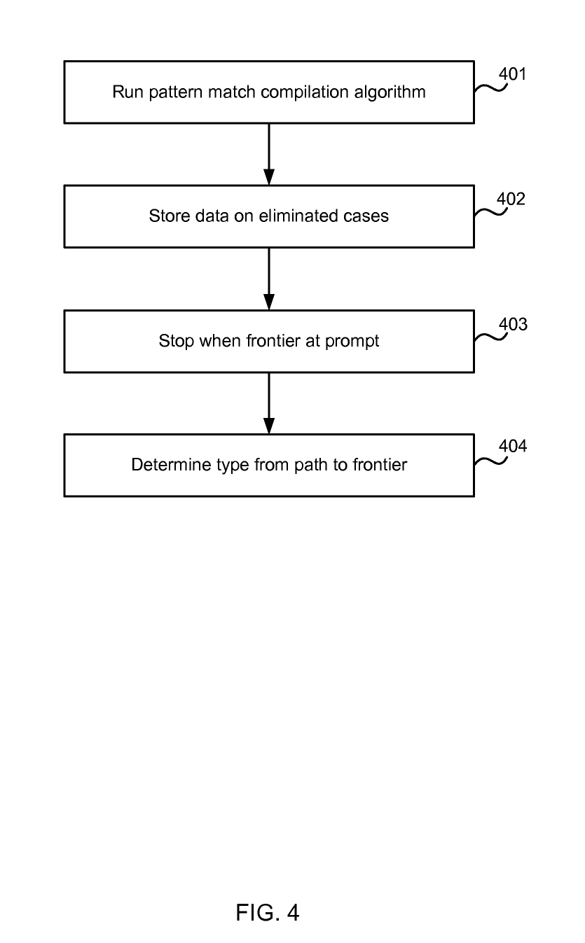

An example flow diagram of a method of determining the type using such a pattern matching algorithm, such as that described above, is shown in FIG. 4. This algorithm described in the paper referenced above is recursive and may be run (block 401) until there is a frontier at the point of investigation (i.e. at the position of the prompt, indicated by <prompt> in the examples above, block 403). The type can be determined from the path taken to that point (block 404). The algorithm performs recursive elimination (also referred to as recursive simplification) and whilst the algorithm is run, a table of cases which have been eliminated is maintained (block 402) and this data is used to determine the previous decomposition constructs (required for blocks 104, 202, 203 and 301). In other examples, alternative data structures comprising the same information may be used instead of a table of cases.

Whilst the examples shown above do not show nested decomposition constructs, the method is applicable where the prompt is within a nested structure, such as:

|A(<prompt>)

The method is also applicable where the decomposition is incomplete, for example where the active pattern comprises (A|B|C|_). The prompt may also be in the middle of a pattern, such as:

match xs with
   |A->
   |<prompt>
   |B->
   In this situation, the ‘previous decomposition constructs’ which are used in refining the set of decomposition cases (e.g. in blocks 202, 203 and 301), includes all those constructs within the pattern, and therefore may also be referred to as the existing decomposition constructs for the particular decomposition statement. In this situation, text beyond the pattern may be ignored, rather than text beyond the prompt (although this may be used in other implementations). The method may be applied for any well-formed pattern.

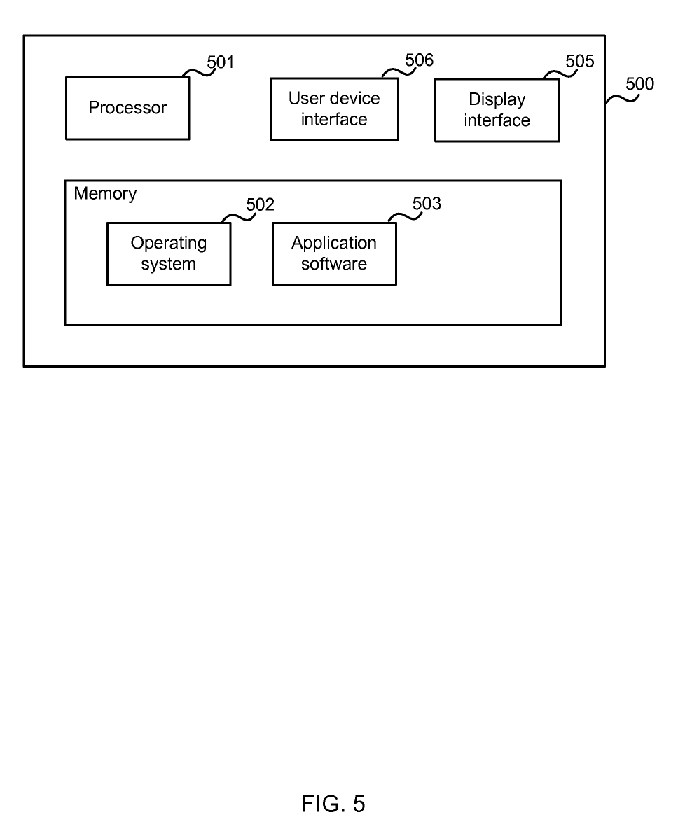

FIG. 5 illustrates various components of an exemplary computing-based device 500 which may be implemented as any form of a computing and/or electronic device, and in which embodiments of the methods described above may be implemented.

Computing-based device 500 comprises one or more processors 501 which may be microprocessors, controllers or any other suitable type of processors for processing computing executable instructions to control the operation of the device in order to perform any of the methods described above. Platform software comprising an operating system 502 or any other suitable platform software may be provided at the computing-based device to enable application software 503 to be executed on the device. The operating system 502 may comprise Microsoft Windows (trade mark) or Vista (trade mark) and the application software 503 may comprise a visual editing application, such as Visual Studio (trade mark).

The computer executable instructions may be provided using any tangible computer-readable media, such as memory 504. The memory may be used to store the operating system 502 and the application software 503. The memory is of any suitable type such as random access memory (RAM), a disk storage device of any type such as a magnetic or optical storage device, a hard disk drive, or a CD, DVD or other disc drive. Flash memory, EPROM or EEPROM may also be used.

The device may further comprise a display interface 505 which is adapted to render the graphical user interface for any software (such as the operating system and application software) on a display device (not shown in FIG. 5).

The computing-based device 500 further comprises one or more inputs which are of any suitable type for receiving media content, Internet Protocol (IP) input etc. An interface 506 to a user input device, such as a keyboard and/or mouse may be provided to enable the user to interact with the application software.

Although the present examples are described and illustrated herein as being implemented in a computer-based system as shown in FIG. 5, the system described is provided as an example and not a limitation. As those skilled in the art will appreciate, the present examples are suitable for application in a variety of different types of computing systems.

The term ‘computer’ is used herein to refer to any device with processing capability such that it can execute instructions. Those skilled in the art will realize that such processing capabilities are incorporated into many different devices and therefore the term ‘computer’ includes PCs, servers, mobile telephones, personal digital assistants and many other devices.

The methods described herein may be performed by software in machine readable form on a storage medium. The software can be suitable for execution on a parallel processor or a serial processor such that the method steps may be carried out in any suitable order, or simultaneously.

This acknowledges that software can be a valuable, separately tradable commodity. It is intended to encompass software, which runs on or controls “dumb” or standard hardware, to carry out the desired functions. It is also intended to encompass software which “describes” or defines the configuration of hardware, such as HDL (hardware description language) software, as is used for designing silicon chips, or for configuring universal programmable chips, to carry out desired functions.

Those skilled in the art will realize that storage devices utilized to store program instructions can be distributed across a network. For example, a remote computer may store an example of the process described as software. A local or terminal computer may access the remote computer and download a part or all of the software to run the program. Alternatively, the local computer may download pieces of the software as needed, or execute some software instructions at the local terminal and some at the remote computer (or computer network). Those skilled in the art will also realize that by utilizing conventional techniques known to those skilled in the art that all, or a portion of the software instructions may be carried out by a dedicated circuit, such as a DSP, programmable logic array, or the like.

Any range or device value given herein may be extended or altered without losing the effect sought, as will be apparent to the skilled person.

It will be understood that the benefits and advantages described above may relate to one embodiment or may relate to several embodiments. It will further be understood that reference to ‘an’ item refers to one or more of those items.

The steps of the methods described herein may be carried out in any suitable order, or simultaneously where appropriate. Additionally, individual blocks may be deleted from any of the methods without departing from the spirit and scope of the subject matter described herein. Aspects of any of the examples described above may be combined with aspects of any of the other examples described to form further examples without losing the effect sought.

It will be understood that the above description of a preferred embodiment is given by way of example only and that various modifications may be made by those skilled in the art. The above specification, examples and data provide a complete description of the structure and use of exemplary embodiments of the invention. Although various embodiments of the invention have been described above with a certain degree of particularity, or with reference to one or more individual embodiments, those skilled in the art could make numerous alterations to the disclosed embodiments without departing from the spirit or scope of this invention.

1. A method of prompting at a point of investigation in a visual editing environment comprising:
determining a type associated with data being decomposed;
identifying at least one set of decomposition cases based on said type;
removing those members from said at least one set of decomposition cases which correspond to existing decomposition constructs to produce a refined set of decomposition cases; and
presenting said refined set of decomposition cases as a visual prompt.

2. A method according to claim 1, further comprising prior to determining a type associated with data being decomposed:
receiving an input from a user identifying said point of investigation.

3. A method according to claim 1, wherein said type has at least one defined active pattern and wherein identifying at least one set of decomposition cases based on said type comprises:
identifying a set of decomposition cases for each active pattern defined for said type.

4. A method according to claim 3, wherein removing those members from said at least one set of decomposition cases which correspond to existing decomposition constructs to produce a refined set of decomposition cases comprises:
determining one or more possible sets of decomposition cases from a group of sets comprising a set for each said active pattern based on existing decomposition constructs; and
creating a refined set of decomposition cases from said one or more possible sets of decomposition cases by removing those members which correspond to existing decomposition constructs.

5. A method according to claim 1, wherein determining a type associated with data being decomposed comprises:
running a pattern match compilation algorithm until a frontier is located at said point of investigation;
storing data identifying cases eliminated whilst running said algorithm; and
determining said type based on a path to said frontier located at said point of investigation.

6. A method according to claim 5, further comprising:
determining existing decomposition constructs from said data identifying cases eliminated whilst running said algorithm.

7. A method according to claim 1, wherein said point of investigation comprises a cursor position in a piece of code written in a programming language with a decomposition construct.

8. A method according to claim 7, wherein said programming language is F#.

9. A method of providing visual prompts in a visual editing environment, the prompts corresponding to a point of investigation within a decomposition statement, and the method comprising:
determining a type associated with an input of said decomposition statement;
determining one or more decomposition cases associated with said type;
identifying possible decomposition cases from said one or more decomposition cases based on existing decomposition constructs for said decomposition statement; and
presenting said possible decomposition cases as a visual prompt.

10. A method according to claim 9, wherein identifying possible decomposition cases from said one or more decomposition cases based on existing decomposition constructs comprises:
removing those decomposition cases from said one or more decomposition cases which correspond to existing decomposition constructs for said decomposition statement.

11. A method according to claim 9, wherein a plurality of active patterns are defined for said type and wherein determining one or more decomposition cases associated with said type comprises:
identifying one or more decomposition cases for each of said plurality of active patterns.

12. A method according to claim 11, wherein identifying possible decomposition cases from said one or more decomposition cases based on existing decomposition constructs comprises:
identifying possible decomposition cases from said one or more decomposition cases based on existing decomposition constructs and said plurality of active patterns.

13. A method according to claim 11, wherein identifying possible decomposition cases from said one or more decomposition cases based on existing decomposition constructs comprises:
identifying possible active patterns based on said one or more decomposition cases for each of said active patterns and on existing decomposition constructs; and
identifying possible decomposition cases comprising said one or more decomposition cases for each of said possible active patterns except for those decomposition cases which correspond to existing decomposition constructs for said decomposition statement.

14. One or more tangible device-readable media with device-executable instructions for performing steps comprising:
determining a type associated with data being decomposed;
identifying at least one set of decomposition cases based on said type;
removing those members from said at least one set of decomposition cases which correspond to existing decomposition constructs to produce a refined set of decomposition cases; and
presenting said refined set of decomposition cases as a visual prompt.

15. One or more tangible device-readable media according to claim 14, further comprising device-executable instructions for performing, prior to determining a type associated with data being decomposed:
receiving an input from a user identifying said point of investigation.

16. One or more tangible device-readable media according to claim 14, wherein said type has at least one defined active pattern and wherein identifying at least one set of decomposition cases based on said type comprises:
identifying a set of decomposition cases for each active pattern defined for said type.

17. One or more tangible device-readable media according to claim 16, wherein removing those members from said at least one set of decomposition cases which correspond to existing decomposition constructs to produce a refined set of decomposition cases comprises:
determining one or more possible sets of decomposition cases from a group of sets comprising a set for each said active pattern based on existing decomposition constructs; and
creating a refined set of decomposition cases from said one or more possible sets of decomposition cases by removing those members which correspond to existing decomposition constructs.

18. One or more tangible device-readable media according to claim 14, wherein determining a type associated with data being decomposed comprises:
running a pattern match compilation algorithm until a frontier is located at said point of investigation;
storing data identifying cases eliminated whilst running said algorithm; and
determining said type based on a path to said frontier located at said point of investigation.

19. One or more tangible device-readable media according to claim 18, further comprising device-executable instructions for performing steps comprising:
determining existing decomposition constructs from said data identifying cases eliminated whilst running said algorithm.

20. One or more tangible device-readable media according to claim 14, wherein said point of investigation comprises a cursor position in a piece of code written in a programming language with a decomposition construct.
